(19) United States
(12) Patent Application Publication
(10) Pub. No.: US 2022/0214022 A1
(43) Pub. Date: Jul. 7, 2022

(54) COMBINED LENS COMPRISING OF LENS AND REFLECTOR, AND VEHICLE LAMP MODULE WITH SAME

(71) Applicant: HASCO VISION TECHNOLOGY CO., LTD, Shanghai (CN)

(72) Inventor: Jie ZHANG, Shanghai (CN)

(73) Assignee: HASCO VISION TECHNOLOGY CO., LTD, Shanghai (CN)

(21) Appl. No.: 17/607,406

(22) PCT Filed: Jul. 20, 2019
(86) PCT No.: PCT/CN2019/096955

§ 371 Date: Oct. 29, 2021

(30) Foreign Application Priority Data
Jul. 11, 2019 (CN) 201910625500.7

(51) Int. Cl. F21S 41/275; F21S 41/32; F21S 41/675; F21S 43/40

(52) U.S. Cl. CPC F21S 41/275; F21S 41/323; F21W 2107/10; F21S 43/40; F21S 41/675

(57) ABSTRACT

The invention relates to a combined lens at least includes a lens and a reflector. Viewed from a reflective light path, parallel light is refracted twice by an incident surface and an emergent surface of the lens, is reflected once by the reflector, and then is converged to one point, namely a focus of the combined lens. A distance between the lens and the reflector is less than a focal length of the lens. The lens may be a convex lens or a concave lens, and the reflector may be a convex mirror, a plane mirror or a concave mirror. In addition, in a traditional lens, a focus position is controlled through two optical surfaces, namely an incident surface and an emergent surface, the lens is usually thicker in the case of the same focal length, and moreover, an optical axis direction is generally a center line of the lens.

### BACKGROUND OF THE INVENTION

### 1. Technical Field

The invention relates to a vehicle lamp module, and in particular to a combined lens comprising of a lens and a reflector, and a vehicle lamp module with the same.

### 2. Description of Related Art

A lens adopted by an existing vehicle lamp system is generally a plano-convex lens, and parallel light is refracted twice through an outer surface and an inner surface of the plano-convex lens and then converged to a point, namely a focus, as shown in FIG. 1.

An existing vehicle lamp system is shown in FIG. 2, a light source 1 is disposed at a first focus an ellipsoid-like reflecting surface of a reflecting cup 2 and is converged near a second focus, and the second focus the ellipsoid-like surface is disposed at a focus of a plano-convex lens 4. In the case of a vehicle lamp system requiring a light-dark cut-off line, such as a lower beam illumination system, a light barrier 3 is disposed at the focus of the plano-convex lens for forming a light-dark cut-off line for illumination, as shown in FIG. 3.

The Chinese patent document with the publication date of Nov. 5, 2008 and the document number CN101298906A discloses a biconvex lens, the principle of which is similar to that of a conventional plano-convex lens, that is, parallel light is refracted twice when passing through the biconvex lens and is converged at a focus.

The above vehicle lamp system has the defects that: the first focus and the second focus of the ellipsoid-like reflecting surface and the lens are disposed in a straight line, resulting in a long front-back dimension, so that a space structure of a vehicle lamp is limited.

In addition, the size of the plano-convex lens is thick, which is not beneficial to product molding. Particularly, more and more lenses are formed by plastic injection molding, the thicker the lens, the longer the molding time and the cooling time of the lens are, and the lens is likely to be subjected to cooling deformation to cause focal length instability. However, if the thickness of the lens is reduced, the focal length will become longer, which also results in increasing of a front-back length of the vehicle lamp, so that a vehicle lamp space is limited.

### BRIEF SUMMARY OF THE INVENTION

The objective of the invention is to provide a combined lens comprising of a lens and a reflector, and a vehicle lamp module with the same. The combined lens can shorten a distance in a front-back direction of a vehicle lamp, is beneficial to achieving structural compactness of the vehicle lamp, and is particularly suitable for the design of the vehicle lamp with strict limitation on the distance in the front-back direction of the vehicle lamp.

The invention adopts the following technical solutions:

A combined lens comprising of a lens and a reflector at least includes a lens and a reflector. Viewed from a reflective light path, parallel light is refracted twice by an incident surface and an emergent surface of the lens, is reflected once by the reflector, and then is converged to one point, namely a focus A of the combined lens. A distance between the lens and the reflector is less than a focal length of the lens.

Preferably, the lens is a convex lens or a concave lens, the reflector is a convex mirror, a plane mirror or a concave mirror, and the number of reflecting surfaces of the lens and the reflector is 1 or several.

Preferably, reflecting surfaces of the reflector are two or more curved surfaces, and can form two or more focuses A by combining with the lens.

Preferably, a reflecting surface of the reflector is a revolution curved surface, and forms continuous focuses by combining with the lens, and the continuous focuses form a curve.

Preferably, an optical axis of the combined lens is divided into two optical axes, namely a reflecting surface optical axis and a lens optical axis.

Further, the optical axis is divided into a lens main optical axis, and one or more reflecting surface sub optical axes.

A vehicle lamp module includes any one of the above combined lenses.

Preferably, a first reflector 2, a second reflector and a lens 4 are sequentially disposed along a light path direction. The second reflector is a plane reflector 5 or a curved surface reflector 6. When the second reflector is the plane reflector 5: a focus 7 of the lens determined by reflection of the plane reflector is located at a focus position of the first reflector 2. When the second reflector is the curved surface reflector 6: the curved surface reflector 6 receives reflected light from the first reflector 2, and converges and reflects the light forwards, and the light is further converged by the lens 4 and then is emitted forwards.

Preferably, the first reflector 2 adopts an ellipsoidal structure. A first focus of the ellipsoidal structure is the same as a focus of the combined lens, and a light source is disposed at a second focus of the ellipsoidal structure.

Preferably, the first reflector 2 is located below the plane reflector 5, and the lens 4 is located in front of the plane reflector 5.

Preferably, the curved surface reflector 6 is located above or behind the first reflector 2, and the lens 4 is located in front of the curved surface reflector 6.

Further, a front end of the lens 4 does not exceed a front end of the first reflector 2 in a front-back direction.

Furthermore, emergent light of the lens 4 is approximate to parallel light.

An adjusting method of a combined lens comprising of a lens and a reflector adopts the above combined lens. When a second reflector is a plane reflector 5, a focus of the lens 4 is adjusted by adjusting an inclination angle of the plane reflector 5. When the second reflector is a curved surface reflector 6, a light convergence degree of the curved surface reflector 6 is adjusted by adjusting a curvature of the curved surface reflector 6, and then a thickness of the lens 4 is adjusted.

The invention has the beneficial effects:

1) The second reflector is added, so that a certain included angle is formed in an emergent direction of light, components in the vehicle lamp may be disposed not along a length direction, a front-back distance of the vehicle lamp module is shortened, and the limitation on a space of the vehicle lamp is relieved.

2) When the second reflector is disposed as the plane reflector, a focus position of the lens may be adjusted by adjusting the inclination angle of the plane reflector, so that the position of the lens and positions of other components in the vehicle lamp module are conveniently adjusted, and adjustability is greatly improved.

3) When the second reflector is disposed as a curved surface reflector (preferably disposed as an arc surface reflector), the second reflector itself may generate a certain convergence effect on light, so that a convergence effect of the lens may be relieved, and then a thinner lens may be adopted. Thinning of the is beneficial to stability of the focal length of the lens, and meanwhile is beneficial to shortening a front-back length of the vehicle lamp module so as to avoid limitation of the space of the vehicle lamp.

4) By thinning the lens, a dispersion degree may be weakened, and adverse effects of dispersion on light color changes are reduced.

### BRIEF DESCRIPTION OF THE SEVERAL VIEWS OF THE DRAWINGS

FIG. 1 is a schematic diagram of light emitted from a focus of a lens in the prior art, refracted twice and then emitted as parallel light.

FIG. 2a is a front view of a vehicle lamp module comprising of a lens and a reflector in the prior art.

FIG. 2b is a left view of FIG. 2a.

FIG. 2c is a cross-sectional view of a medial surface of FIG. 2b.

FIG. 2d is a cross-sectional view of a lens.

FIG. 3 is a principle diagram of the vehicle lamp module in FIG. 2c, showing light reflection and refraction directions.

FIG. 4 is a schematic diagram of explaining a change in a focus of a convex lens by using a plane reflector in order to illustrate a solution of Embodiment 1 of the invention.

FIG. 5a is a right view of FIG. 5b.

FIG. 5b is a front view of a vehicle lamp module adopting a combined lens comprising of a lens and a reflector of the invention in Embodiment 1.

FIG. 5c is a cross-sectional view of a medial surface in FIG. 5b.

FIG. 6 is a schematic diagram of a structural principle of a combined lens comprising of a lens and a reflector in Embodiment 1 of the invention.

FIG. 7 is a schematic diagram showing an effect of a longer focal length of a thinner lens, only for showing a principle.

FIG. 8a is a right view of FIG. 8b.

FIG. 8b is a front view of a second reflector being a curved surface reflector.

FIG. 8c is a cross-sectional view of a medial surface of FIG. 8b, which is a schematic diagram explaining that use of a curved surface reflector can generate a certain convergence effect on light emitted to the lens to illustrate a solution in Embodiment 2 of the invention; preferably, light emitted to the curved surface reflector passes through one of focuses thereof, and the focus has been shown in FIG. 8c.

FIG. 8d is a bottom view of FIG. 8b.

FIG. 9a is a right view of FIG. 9b.

FIG. 9b is a front view of a vehicle lamp module adopting a combined lens comprising of a lens and a reflector of the invention in Embodiment 2.

FIG. 9c is a cross-sectional view of a medial surface of FIG. 9b.

FIG. 10 is a schematic diagram of a structural principle of a combined lens comprising of a lens and a reflector in Embodiment 2 of the invention.

FIG. 11 is a schematic diagram of a structural principle of a combined lens comprising of a lens and a reflector in Embodiment 3 of the invention.

FIG. 12 is a front view of a combined lens comprising of a lens and a reflector in Embodiment 3 of the invention.

FIG. 13 is a schematic cross-sectional view of a combined lens comprising of a lens and a reflector in Embodiment 4 of the invention.

FIG. 14 is a stereoscopic exposed view of a combined lens comprising of a lens and a reflector in Embodiment 4 of the invention.

Reference numerals: 1, light source; 2, first reflector; 3, light barrier; 4, lens; 5, plane reflector; 6, curved surface reflector; A, focus of combined lens.

### DETAILED DESCRIPTION OF THE INVENTION

The invention will be described further with reference to the accompanying drawings and specific embodiments.

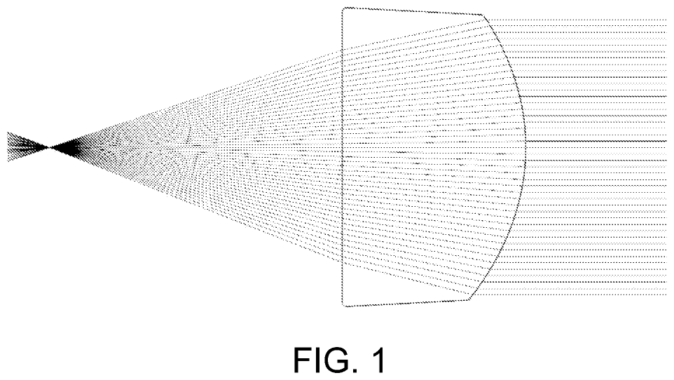

With reference to FIG. 1, light emitted from a focus of a lens is refracted twice and then emitted as parallel light, which is the prior art.

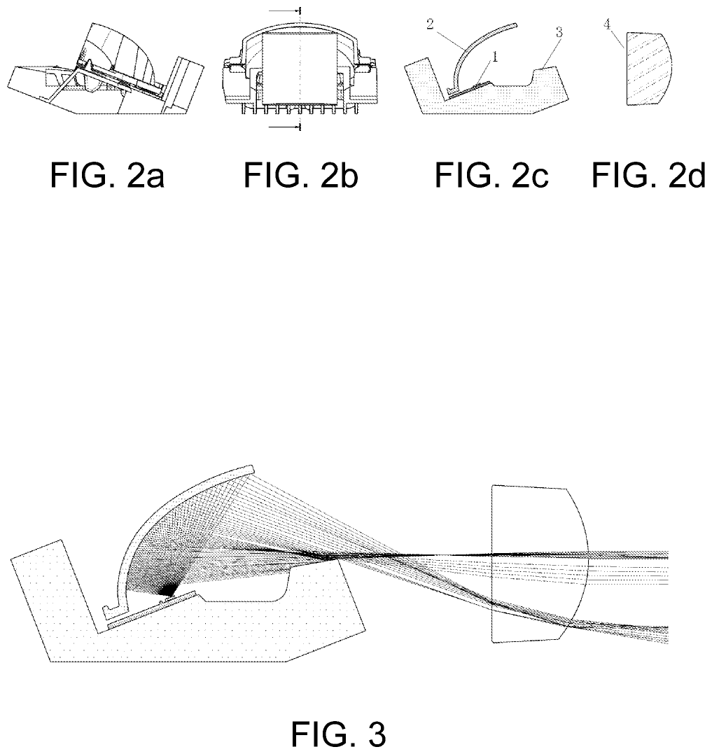

FIGS. 2a-2d are a vehicle lamp module comprising of a lens and a reflector in the prior art. A light source 1 is disposed at a first focus of an ellipsoid-like reflecting surface of a reflecting cup 2 and is converged near a second focus, and the second focus the ellipsoid-like surface is disposed at a focus of a plano-convex lens 4. In the case of a vehicle lamp system requiring a light-dark cut-off line, such as a lower beam illumination system, a light barrier 3 is disposed at the focus of the plano-convex lens for forming a light-dark cut-off line for illumination, as shown in FIG. 3. It can be found that the first focus and the second focus of the ellipsoid-like reflecting surface and the lens are disposed in a straight line, resulting in a long front-back dimension, so that a space structure of a vehicle lamp is limited.

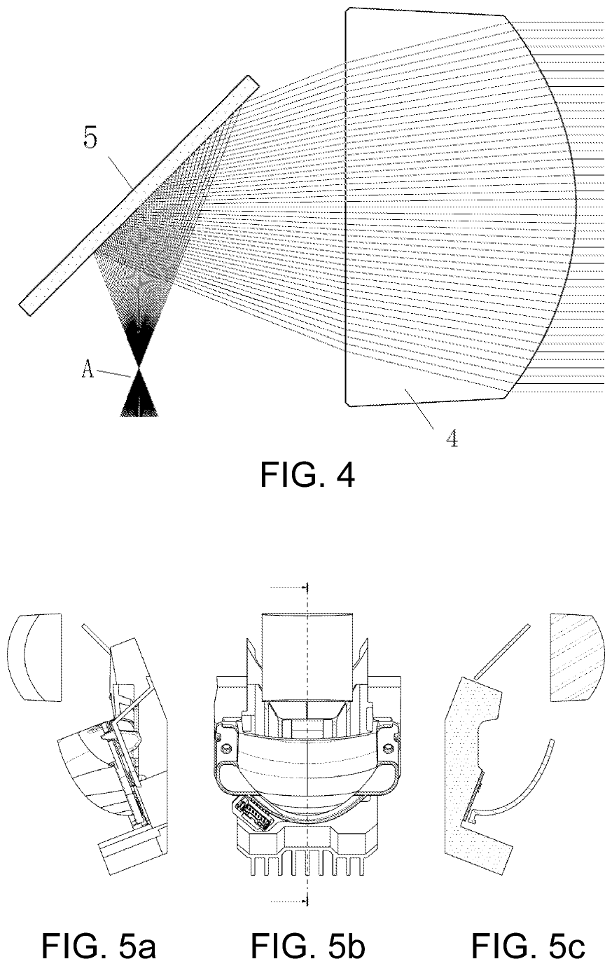

FIG. 4 is a schematic diagram of explaining a change in a focus of a convex lens by using a plane reflector in order to illustrate a solution of Embodiment 1 of the invention. Because the position of the focus of the lens may be changed by the plane reflector 5, the focus is located at the position A in FIG. 4.

### Embodiment 1

With reference to FIGS. 4-8d, a combined lens comprising of a lens and a reflector at least includes a lens and a reflector. Viewed from a reflective light path, parallel light is refracted twice by an incident surface and an emergent surface of the lens, is reflected once by the reflector, and then is converged to one point, namely a focus A of the combined lens. A distance between the lens and the reflector is less than a focal length of the lens.

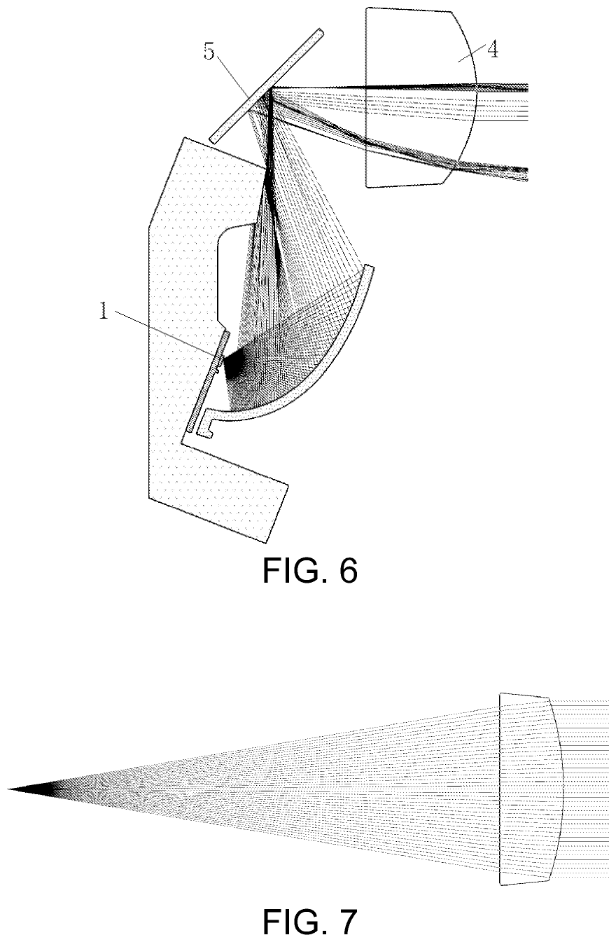

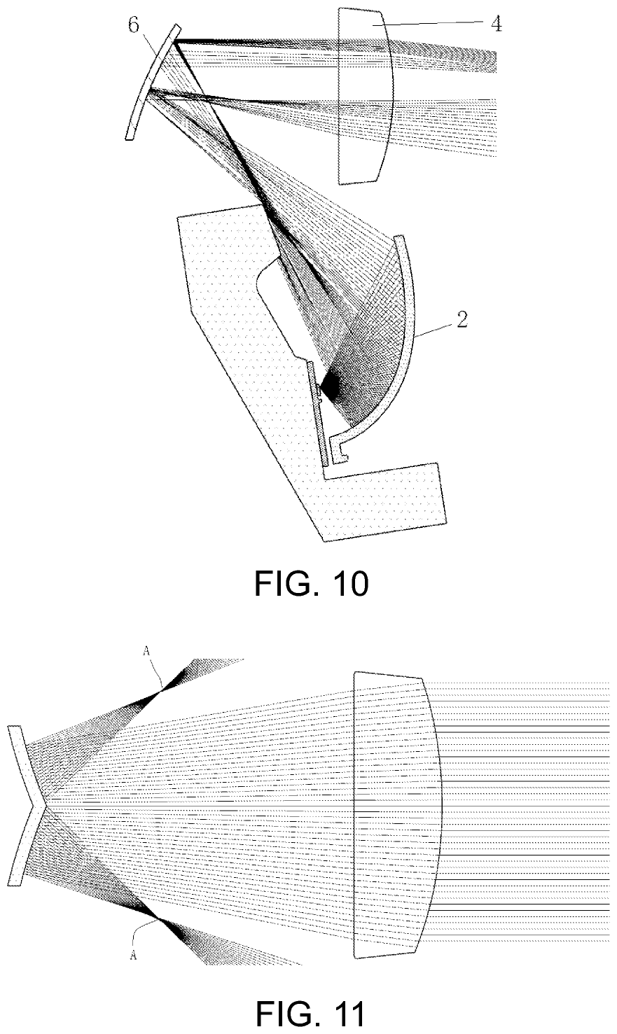

In this embodiment, the lens may be a convex lens or a concave lens. Only the convex lens is shown in the accompanying drawings, but actually the concave lens is also available. The reflector may be a convex mirror, a plane mirror or a concave mirror. The plane mirror is adopted in FIG. 6, and the concave mirror is adopted in FIG. 10. The number of reflecting surfaces of the lens and the reflector is 1 or several. Only one reflecting surface is adopted in each of FIGS. 6 and 10, while a plurality of reflecting surfaces are adopted in FIGS. 11-14.

Reflecting surfaces of the reflector are two or more curved surfaces, and can form two or more focuses A by combining with the lens, as shown in FIG. 11.

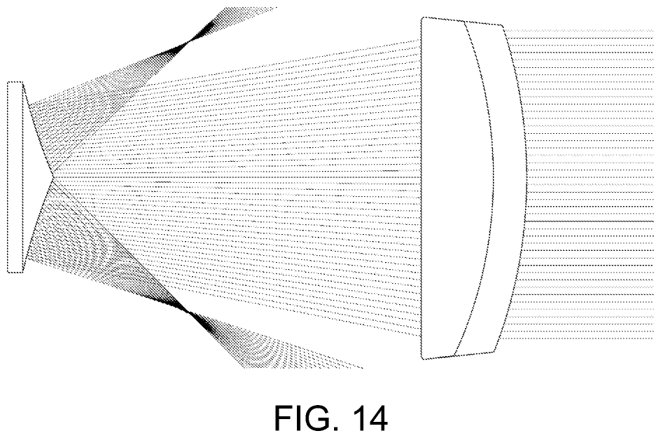

A reflecting surface of the reflector is a revolution curved surface, and forms continuous focuses by combining with the lens, and the continuous focuses form a curve, as shown in FIGS. 13-14.

An optical axis of the combined lens is divided into two optical axes, namely a reflecting surface optical axis and a lens optical axis. The optical axis is divided into a lens main optical axis, and one or more reflecting surface sub optical axes, as shown in FIGS. 11-14.

With reference to FIGS. 5a-5d and FIG. 6, a combined lens comprising of a lens and a reflector includes a first reflector 2, a second reflector and a lens 4 which are sequentially disposed along a light path direction. The second reflector is a plane reflector 5. When the second reflector is the plane reflector 5: a focus A of the lens determined by reflection of the plane reflector is located at a focus position of the first reflector 2.

Preferably, with continued reference to FIG. 6, the first reflector 2 is located below the plane reflector 5, and the lens 4 is located in front of the plane reflector 5.

With reference to FIG. 6, emergent light of the lens 4 is approximate to parallel light.

An adjusting method of a combined lens comprising of a lens and a reflector adopts the above combined lens. A focus of the lens 4 is adjusted by adjusting an inclination angle of the plane reflector 5.

### Embodiment 2

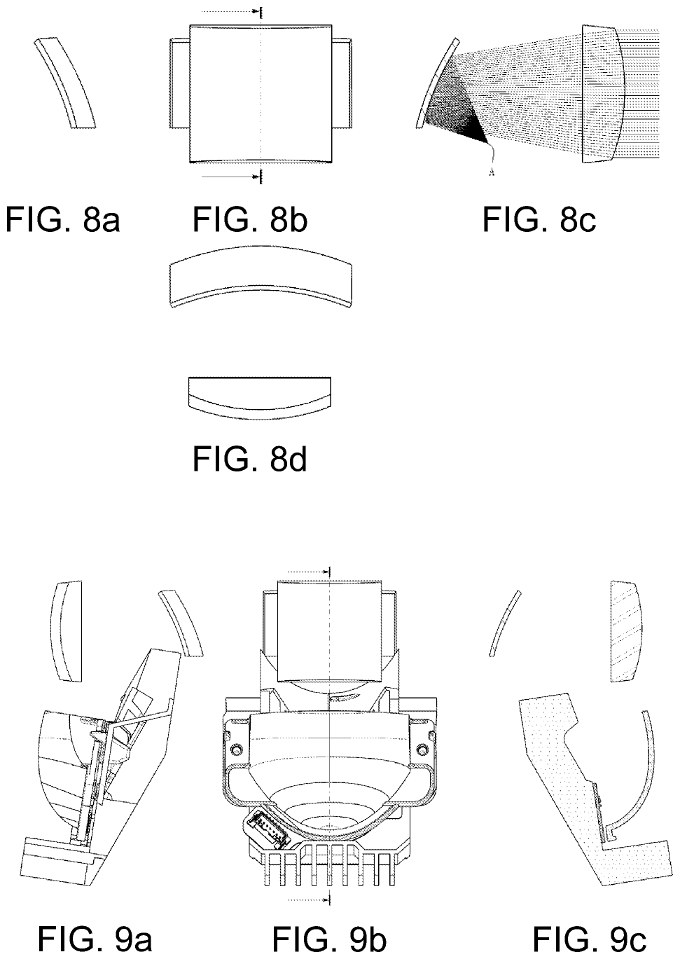

With reference to FIGS. 8a-8d, FIGS. 8a-8d is a schematic diagram explaining that use of a curved surface reflector can generate a certain convergence effect on light emitted to a lens to illustrate a solution in Embodiment 2 of the invention. Preferably, light emitted to the curved surface reflector passes through one of focuses thereof, and the focus has been shown in FIG. 8c.

With reference to FIGS. 9a-9d and FIG. 10, a lens module includes a first reflector 2, a second reflector and a lens 4 which are sequentially disposed in a light path direction. The second reflector is a curved surface reflector 6. The curved surface reflector 6 receives reflected light from the first reflector 2, and converges and reflects the light forwards, and the light is further converged by the lens 4 and then is emitted forwards.

In a preferable solution, the first reflector 2 adopts an ellipsoidal structure. A first focus of the ellipsoidal structure is the same as a focus of the combined lens, and a light source is disposed at a second focus of the ellipsoidal structure, so that emergent light approximate to parallel light may be obtained.

With continued reference to FIG. 10, in orientation setting of components, the first reflector 2 is located below a plane reflector 5, and the lens 4 is located in front of the plane reflector 5.

As a preferable solution, the curved surface reflector 6 is located above and behind the first reflector 2, and the lens 4 is located in front of the curved surface reflector 6. The setting of this position relation is beneficial to further shortening a distance of the combined lens of a vehicle lamp in a front-back direction, and saving space.

As a further preferable solution, a front end of the lens 4 does not exceed a front end of the first reflector 2 in a front-back direction.

With reference to FIG. 10, emergent light of the lens 4 is approximate to parallel light.

An adjusting method of a combined lens comprising of a lens and a reflector adopts the above combined lens. A light convergence degree of a curved surface reflector 6 is adjusted by adjusting a curvature of the curved surface reflector 6, and then a thickness of the lens 4 is adjusted.

### Embodiment 3

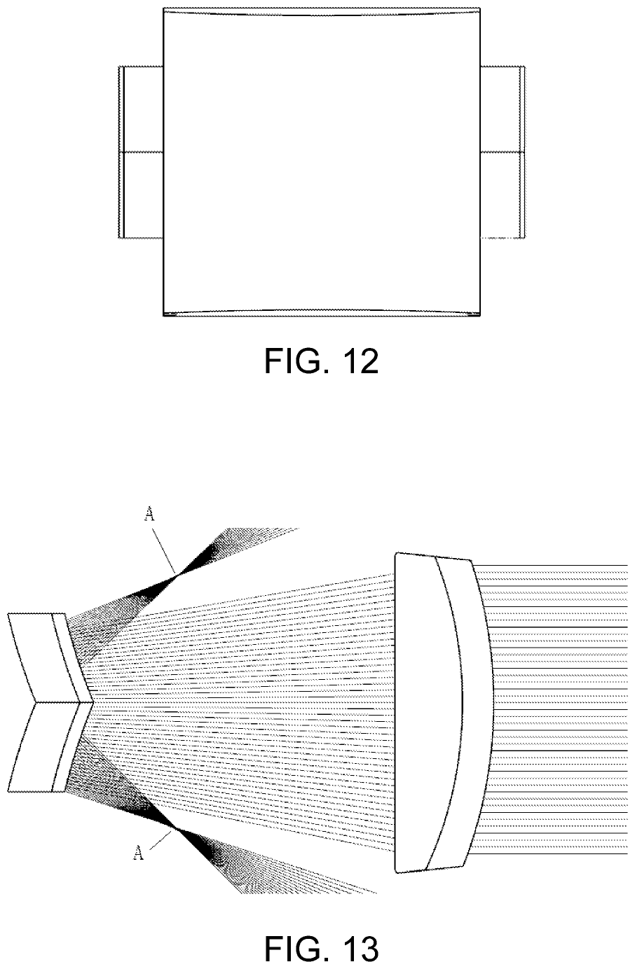

FIG. 11 is a schematic diagram of a structural principle of a combined lens comprising of a lens and a reflector in Embodiment 3 of the invention. FIG. 12 is a front view of a combined lens comprising of a lens and a reflector in Embodiment 3 of the invention.

Only in view of the combined lens, the difference from Embodiment 1 lies in that reflecting surfaces of the reflector are two or more curved surfaces, and can form two or more focuses A by combining with the lens. As shown in FIG. 11, FIG. 11 shows the case of two focuses, and actually a plurality of focuses may also be formed in a circumferential direction.

An optical axis of the combined lens is divided into two optical axes, namely a reflecting surface optical axis and a lens optical axis. The optical axis is divided into a lens main optical axis, and one or more reflecting surface sub optical axes, as shown in FIGS. 11-12.

The rest is the same as that of Embodiment 1.

### Embodiment 4

FIG. 13 is a schematic cross-sectional view of a combined lens comprising of a lens and a reflector in Embodiment 4 of the invention. FIG. 14 is a stereoscopic exposed view of a combined lens comprising of a lens and a reflector in Embodiment 4 of the invention.

Only in view of the combined lens, the difference from Embodiment 3 lies in that a reflecting surface of the reflector is a revolution curved surface, and forms continuous focuses by combining with the lens, and the continuous focuses form a curve, as shown in FIGS. 13-14.

The rest is the same as that of Embodiment 3.

The above are the preferred embodiments of the invention, those of common skill in the art may also make various transformations or improvements on this basis. Without deviating from the general idea of the invention, these transformations or improvements should fall within the scope of protection claimed by the invention.

1. A combined lens comprising: a lens and a reflector, wherein viewed from a reflective light path, parallel light is refracted twice by an incident surface and an emergent surface of the lens, is reflected once by the reflector, and then is converged to one point, namely a focus of the combined lens, and a distance between the lens and the reflector is less than a focal length of the lens.

2. The combined lens according to claim 1, wherein the lens is a convex lens or a concave lens, the reflector is a convex mirror, a plane mirror or a concave mirror, s number of reflecting surfaces of the lens and the reflector is 1 or several.

3. The combined lens according to claim 1, wherein reflecting surfaces of the reflector are two or more curved surfaces, and can form two or more focuses by combining with the lens.

4. The combined lens according to claim 1, wherein a reflecting surface of the reflector is a revolution curved surface, and forms continuous focuses by combining with the lens, and the continuous focuses form a curve.

5. The combined lens according to claim 1, wherein an optical axis of the combined lens is divided into two optical axes, namely a reflecting surface optical axis and a lens optical axis.

6. The combined lens according to claim 5, wherein the optical axis is divided into a lens main optical axis, and one or more reflecting surface sub optical axes.

7. A vehicle lamp module, comprising a combined lens according to claim 1.

8. The vehicle lamp module as claim 7, wherein
a first reflector, a second reflector and a lens are sequentially disposed along a light path direction;
the second reflector is a plane reflector or a curved surface reflector;
when the second reflector is the plane reflector: a focus of the lens determined by reflection of the plane reflector is located at a focus position of the first reflector; and
when the second reflector is the curved surface reflector: the curved surface reflector receives reflected light from the first reflector, and converges and reflects the light forwards, and the light is further converged by the lens and then is emitted forwards.

9. The vehicle lamp module as claim 7, wherein the first reflector adopts an ellipsoidal structure, a first focus of the ellipsoidal structure is the same as a focus of the combined lens, and a light source is disposed at a second focus of the ellipsoidal structure.

10. The vehicle lamp module as claim 7, wherein the first reflector is located below the plane reflector, and the lens is located in front of the plane reflector.

11. The vehicle lamp module as claim 7, wherein the curved surface reflector is located above or behind the first reflector, and the lens is located in front of the curved surface reflector.

12. The vehicle lamp module as claim 11, wherein a front end of the lens does not exceed a front end of the first reflector in a front-back direction.

13. The vehicle lamp module as claim 12, wherein emergent light of the lens is approximate to parallel light.

14. An adjusting method of a combined lens comprising of a lens and a reflector, comprising:
adopting the combined lens of claim 1;
when a second reflector is a plane reflector, adjusting a focus of the lens by adjusting an inclination angle of the plane reflector; and
when the second reflector is a curved surface reflector, adjusting a light convergence degree of the curved surface reflector by adjusting a curvature of the curved surface reflector, and then adjusting a thickness of the lens.

15. A vehicle lamp module, comprising a combined lens according to claim 2.

16. The vehicle lamp module as claim 15, wherein
a first reflector, a second reflector and a lens are sequentially disposed along a light path direction;
the second reflector is a plane reflector or a curved surface reflector;
when the second reflector is the plane reflector: a focus of the lens determined by reflection of the plane reflector is located at a focus position of the first reflector; and
when the second reflector is the curved surface reflector: the curved surface reflector receives reflected light from the first reflector, and converges and reflects the light forwards, and the light is further converged by the lens and then is emitted forwards.

17. The vehicle lamp module as claim 15, wherein the first reflector adopts an ellipsoidal structure, a first focus of the ellipsoidal structure is the same as a focus of the combined lens, and a light source is disposed at a second focus of the ellipsoidal structure.

18. The vehicle lamp module as claim 15, wherein the first reflector is located below the plane reflector, and the lens is located in front of the plane reflector.

19. The vehicle lamp module as claim 15, wherein the curved surface reflector is located above or behind the first reflector, and the lens is located in front of the curved surface reflector.

20. The vehicle lamp module as claim 19, wherein a front end of the lens does not exceed a front end of the first reflector in a front-back direction.
